(19) United States
(12) Patent Application Publication
(10) Pub. No.: US 2016/0045866 A1
(43) Pub. Date: Feb. 18, 2016

(54) DEVICE OF DEODORIZING AND MINIMIZING VOC IN EXHAUST GAS WITH PHOTOCATALYST

(71) Applicant: NATIONAL CHUNG SHAN INSTITUTE OF SCIENCE AND TECHNOLOGY, TAIWAN (CN)

(72) Inventors: WEI-HONG WANG, TAIWAN (CN); CHIA-TING LIN, TAIWAN (CN); CHIH-MO CHIU, TAIWAN (CN); JILN-FUH YAU, TAIWAN (CN)

(21) Appl. No.: 14/460,437

(22) Filed: Aug. 15, 2014

(51) Int. Cl. B01D 53/94; B01D 53/38

(52) U.S. Cl. CPC B01D 53/94; B01D 53/38; B01D 2255/802; B01D 2255/915

(57) ABSTRACT

A device of deodorizing and minimizing VOC in exhaust gas with photocatalyst is equipped with UV lamp wrapped with photocatalyst coating fiberglass sleeve, disposed in an exhaust gas treatment chamber. At an inlet end, exhaust gas passes an activated carbon honeycomb plate which adsorbs VOC gas of the exhaust gas. The photocatalyst-based exhaust gas treatment chamber is installed in a manner to face the sun. Sunlight falls on the exhaust gas treatment chamber, thus causes the activated carbon honeycomb plate to release the otherwise adsorbed VOC gas. After that, undergoing photocatalyst-based exhaust-gas-borne VOC treatment system, the released VOC gas is oxidized and discharged without odorous.

### FIELD OF THE TECHNOLOGY

The present invention relates to devices of deodorizing and minimizing VOC (volatile organic compounds) in exhaust gas with photocatalyst, and more particularly, a device of deodorizing and minimizing VOC in exhaust gas with photocatalyst, wherein the device eliminates VOC from the exhaust-gas discharged from household kitchens and restaurant kitchens. The device essentially comprises a photocatalyst-based exhaust gas treatment ultraviolet (UV) chamber to perform photocatalyst-based exhaust gas treatment with sunlight in the daytime, and perform photocatalyst-based exhaust gas treatment by the UV lamp in the absence of sunlight.

### BACKGROUND OF THE TECHNOLOGY

Pollutants attributable typically to catering services fall into two categories, namely particulate oil mist and gas. Particulate oil mist includes toxic compounds, such as polycyclic aromatic hydrocarbons (PAHs), nitrated-polycyclic aromatic hydrocarbons (N-PAHs), and heterocyclic amines, etc. Gaseous pollutants are represented by trimethyl amine, aldehyde and others as volatile organic compound (VOC) in air. When inhaled, the VOC gas which originates from exhaust air can induce free radicals at the lungs and thus increases the probability of lung cancer, which is one of the major causes of lung cancer among female non-smokers in Taiwan and some other countries.

Good restaurants and catering stores are required to comply with specific discharge standards when it comes to exhaust gas treatment. However, there has hitherto not any effective solution to remove VOC gas from exhaust gas. In this regard, it is especially important to remove VOC-related odor from exhaust gas with an efficient treatment device in densely populated cities where high-rises hamper air diffusion. A conventional exhaust gas treatment device, which operates at kitchens in households and restaurants, comprises a pre-treatment device and a post-treatment device. The pre-treatment device comprises a collection hood, a baffle, and a filter net, wherein particulate oil mist is separated from cooking spurt vapor by exhaust blower, by interception and bombardment. To enhance the efficiency of the treatment of particulate oil mist, a water fall is provided to remove, or an electrostatic fumes collector is used. Nonetheless, the aforesaid prior art fails to remove hazardous VOC gas from exhaust gas completely; as a result, the hazardous VOC gas is releases to the atmosphere and stinks, thereby causing air pollution. In view of this, the purpose of the post-treatment device is to remove hazardous VOC gas from exhaust gas. A common example of post-treatment devices is a wet scrubbing which uses a scrubber to absorb VOC gas and performs VOC oxidative decomposition with chemicals, such as a bleaching agent. However, waste gas treatment carried out with the wet scrubber adds to maintenance costs and produces secondary waste chemicals, and thus is not suitable for use in households and restaurants.

Most VOC gases are odorous. The more strong odorous they are, the more hazardous they are. Some VOC gases have strongly odorous, intensely hazardous and extremely tenacious even when present at a low concentration of a few parts per million (ppm). More badly, some human beings have a sensitive nose and thus can sense VOC gas present at a low concentration of a few parts per billion (ppb). As a result, the odor of VOC gases poses a problem with people living around restaurants in a city.

As mentioned above, the wet scrubbers are not suitable for use in households and restaurants. In view of this, the prior art puts forth dry exhaust-gas-borne VOC treatment devices. As indicated by research papers, dry exhaust gas VOC deodorization treatment technology was launched in 1995 by Japan-based Hitachi, wherein Noriko and others disclose that exhaust gas VOC deodorization treatment is carried out in the presence of Ag—Mn catalyst and at 100 C.°. In 2009, Huang and others from an environment research institute in China disclose removing VOC gas in the presence of Pd/activated carbon and at 140 C.°. In 2009, Tsai Kun-lin and others of Taiwan-based JG Environmental Technology Co., Ltd. disclose a gas purification method whereby sulfide-containing VOC gas odor is removed at 60 C.° with a catalytic filtering unit and an ozone oxidation treatment device. In 2013, Seong and others from an environmental technology research institute in South Korea disclose removing VOC gas odor at room temperature in the presence of a copper phosphate catalyst and by anion filtration. In 2013, Ralf and others of Germany-based INP disclose removing VOC gas odor at room temperature, using activated carbon and plasma. All the aforesaid conventional techniques require heating with thermal process and thus are not applicable to photocatalyst-based exhaust-gas-borne VOC treatment in sunlight.

There are a wide variety of treatment devices for removing VOC from the exhaust gas. U.S. Pat. No. 4,666,677, which was issued to Gary and others of the US-based Continental Thermal Design Co., Ltd. in 1987, discloses a thermo-catalyst for use with an exhaust-gas-borne VOC treatment device to remove VOC gas odor. U.S. Pat. No. 5,290,510, which was issued to Cha J. Lee of South Korea-based Samsung in 1993, discloses a Pt catalyst for use in refrigerator deodorization treatment carried out at 100 C.°. U.S. Pat. No. 5,291,742, which was issued to Kenji and others of Japan-based Mistushita Co., Ltd. in 1994, discloses a catalyst for use in refrigerator deodorization treatment. U.S. Pat. No. 5,482,685, which was issued to Tatsuo and others in 1994, discloses an exhaust-gas-borne VOC treatment device for removing odor by thermo-catalyst-based electrically-driven heating. U.S. Pat. No. 5,681,533, which was issued to Tatsuo Hiromi of Japan-based Yushin Co., Ltd. in 1995, discloses an exhaust-gas-borne VOC treatment device for use in deodorization by electrostatic dust collection, using ozone, an adsorptive material, and deodorization catalyst. U.S. Pat. No. 5,759,496, which was issued to David and others of the US-based Corning Co., Ltd. in 1995, discloses an exhaust-gas-borne VOC treatment device which operates by activated carbon-based electrically-driven heating induced adsorption and desorption as well as a ceramic honeycomb catalyst susceptible to electrically-driven heating. U.S. Pat. No. 5,814,132 and U.S. Pat. No. 5,968,235, which were issued to Thomas and others of the US-based Ramberg Co., Ltd. in 1995, disclose an exhaust-gas-borne VOC treatment device which operates by a combination of aluminum silicate-based heating-induced adsorption and desorption as well as a ceramic honeycomb catalyst-based combustion. U.S. Pat. No. 5,925,321, which was issued to Masanori and others of Japan-based Mistushita Co., Ltd. in 1997, discloses performing trash bin exhaust-gas-borne VOC treatment by thermo-catalyst-based electrically-driven heating with a view to deodorizing the trash bin exhaust gas. U.S. Pat. No. 5,968,235, U.S. Pat. No. 6,251,347, and U.S. Pat. No. 6,479,022, which were issued to Larry and others in 1998, disclose that an exhaust-gas-borne VOC treatment device operates by heating, using a combination of an adsorptive material and a thermo-catalyst. U.S. Pat. No. 6,318,245, which was issued to Wilfried and others of the US-based Rational AG Co., Ltd. in 2001, discloses putting a thermo-catalyst device in an exhaust hood to treat exhaust gas VOC produced during cooking TW 268651, which was issued to Wu Hsi-feng of Taiwan-based Chun Chia Co., Ltd. in 1994, discloses a enameled wire maker catalytic apparatus heating device. All the exhaust-gas-borne VOC treatment devices claimed by the aforesaid patents have drawbacks, namely an intricate process, difficulty in maintenance, high operating costs, being inapplicable to households and restaurants, and not using a photocatalyst in performing exhaust-gas-borne VOC treatment.

Some patents which disclose using a photocatalyst in performing exhaust-gas-borne VOC treatment are described below.

U.S. Pat. No. 5,835,840, entitled Photocatalytic System for Indoor Air Quality, which was issued to D. Yogi Goswami of the US-based Universal Air Co., Ltd. in 1998, discloses performing coated on the filter and screen with photocatalyst, mounting this filter inside the pipelines of an air-conditioning system of a building, disposing an ultraviolet (UV) lamp in front of the filtering screen and the photocatalyst coating to effectuate irradiation, so as to achieve sterilization and deodorization, wherein the exhaust gas treatment device is suitable for use in an air-conditioning system of a building and is best mounted inside the pipelines of the air-conditioning system to effectuate particulate filtration of air and sterilization of air, but is not efficient in treating exhaust VOC gas in the air, not only because VOC gas cannot be filtered, but also because the VOC stays at the photocatalytic filtering screen for just a short period of time and thus cannot undergo oxidation and elimination effectively.

In 2004, Bradley and others of the US-based Carrier Co., Ltd. was issued U.S. Pat. No. 6,716,406, entitled Control System for a Photocatalytic Air Purifier, which discloses applying a photocatalyst coated honeycomb plate, performing irradiation with UV lamps disposed at the front and rear of the honeycomb plate, mounting the honeycomb plate on an exhaust-gas-borne VOC treatment device, with a view to effectuating sterilization and deodorization. U.S. Pat. No. 6,716,406 has drawbacks as follows: ultraviolet is emitted from the UV chamber and then falls on the photocatalyst coating on the honeycomb plate, but the strength of the ultraviolet falling on the photocatalyst coating decreases with distance, even thus the ultraviolet cannot effectively penetrate into the ceramic honeycomb to the photocatalyst coating; and, as mentioned before, it is not efficient in treating exhaust gas VOC in the air.

In 1994, Cheng Wen-hu of Taiwan-based Taiwan Fluorescent Lamp Co., Ltd. was issued Taiwan patent TW 456557, entitled Advertisement and display light box which undergo photocatalyst-based exhaust gas treatment. TW 456557, which is based on Taiwan patent TW 542742 entitled Photocatalyst Waste gas treatment UV lamp and issued to National Chung-Shan Institute of Science & Technology, Armaments Bureau, Ministry of National Defense, Taiwan, discloses that an exhaust gas treatment is disposed in advertisement and display light box, using a fan to circulate air in the light box, thereby purifying ambient air. TW 456557 has drawbacks as follows: the light box requires that an electrically powered lamp treats indoor air that carries VOC of a low concentration for a long period of time and thus is not suitable for use in treating exhaust gas emitted from kitchens at households and restaurants, and in consequence it is not efficient in treating a large amount of fumes and VOC gas emitted instantaneously during cooking.

In 2009, Huang Cheng-chung and others of Vital Air Co., Ltd. were issued Taiwan patent TW M360082 entitled Device for removing volatile organic compound (VOC), which discloses removing exhaust gas VOC which are discharged from restaurants and factories, removing particles and particulate oil mist by an electrostatic exhaust hood, and removing VOC gas with an intense UV chamber and a photocatalyst. TW M360082 has drawbacks as follows: it entails treating VOC gas in exhaust gas by means of the photocatalyst coating on a stainless steel fiber flat screen plate, wherein UV lamp are disposed at the front and rear of the stainless steel screen to effectuate irradiation; the ultraviolet dwindles while irradiating on the photocatalyst coating on the stainless steel screen and fails to reach the photocatalyst behind the screen, and in consequence the VOC decomposition is efficient; it involves using highly dangerous and high-cost UVD 185 nm lamp in producing ozone, irradiating with the dangerous UVC 254 nm lamp, performing photocatalytic oxidation and decomposition of VOC gas in exhaust gas and ozone on the stainless steel screen; as a result, its exhaust-gas-borne VOC treatment not only incurs high costs but is also hazardous and inefficient.

### SUMMARY

As indicated by the aforesaid prior art and patent literature which disclose performing exhaust gas VOC deodorization treatment in the presence of a photocatalyst, the aforesaid prior art and patent literature neither disclose using sunlight as an energy source for the photocatalyst, nor disclose using an activated carbon honeycomb plate to adsorb volatile organic compound (VOC) gas emitted instantaneously from kitchens during cooking, not to mention that they do not disclose performing exhaust-gas-borne VOC treatment in broad sunlight with an activated carbon honeycomb plate chamber and a row of photocatalyst UV lamps chamber.

In view of the aforesaid drawbacks of the prior art, the present invention provides a device of deodorizing and minimizing VOC in exhaust gas with photocatalyst. The device is intended for use in the kitchens of households and restaurants to treat exhaust gas and, in further to, exhaust gas VOC emitted from foods industrial processes.

The present invention involves using a fiberglass sleeve, which is impregnated with nano-TiO₂ Anatase sol, baked the sol-impregnated fiberglass sleeve to obtain a photocatalytic coated fiberglass sleeve, and wrapped on the fluorescent lamp, from different fluorescent lamp for different air cleaning efficiency. Depending on the formula of the TiO₂ Anatase sol, the present invention is capable of visible light-enabled photocatalysis and certainly ultraviolet-enabled photocatalysis. Depending on the fluorescent tube (which emits 254˜385 nm ultraviolet, with an ultraviolet irradiation intensity greater than 1.0 mW/cm²), such as DEX, DL, UVA and UVC lamp, respectively, and, after getting coupled to the photocatalyst coating fiberglass sleeve, the photocatalytic air cleaning lamps are made, manifesting different degrees of efficiency in exhaust gas treatment.

The device of deodorizing and minimizing VOC in exhaust gas with photocatalyst according to the present invention is characterized in that: the immersion coating of a fiberglass sleeve is performed with a highly efficient photocatalytic sol; the fiberglass sleeve is fitted to UV lamp from outside, and thus the manufacturing of a highly efficient photocatalyst-based exhaust gas treatment UV lamp is finalized; and the photocatalyst-based exhaust gas treatment UV lamp is disposed in the photocatalyst-based exhaust gas treatment chamber and arranged parallel row thereto. The exhaust gas treatment chamber panels are made of glass and face sunlight. In the daytime, ultraviolet of sunlight penetrates the glass panels and falls on a photocatalyst disposed in the exhaust gas treatment UV lamp to react with the oxygen and water vapor in the air and thereby bring about photocatalysis, so as to produce hydroxyl free radical .OH and effectuate photocatalyst-based exhaust gas treatment.

The present invention is suitable for use in kitchens of households and small and medium-sized restaurants. Considering the many ways of cooking and the short period of time spent on cooking, the present invention involves using at least an activated carbon honeycomb plate which is disposed at the inlet end of an exhaust gas treatment chamber, wherein a large amount of VOC gas produced as a result of cooking is adsorbed. The panels of the exhaust gas treatment chamber are made of glass. Honeycomb pores formed in an activated carbon honeycomb plate disposed in the exhaust gas treatment chamber face the glass panels of the exhaust gas treatment chamber. In the daytime, sunlight falls on the activated carbon honeycomb plate and thus releases a low concentration of VOC gas. The released VOC gas enters the device by thermal convection. Hence, sunlight effectuates exhaust gas VOC deodorization treatment to thereby extend the response duration of the device, reduce the required volume of the device, and cut device production cost.

The activated carbon honeycomb plate, which is made by wooden papers, be folded and glued together in the shape of a triangle, a square, or a hexagon, and carbonized about 300˜500 C.° in inert atmosphere. It also can be manufactured by being impregnated the honeycomb paper with activated carbon powder slurry, baked at 150 C.°. This activated carbon honeycomb plate can be advanced by impregnated with a solution of a salt of a transition metal, such as Cu, Ag, or Mn, and subjected to carbonization, metal reduction, and baking in the absence of oxygen, and adapted to effectuate exhaust gas VOC adsorption, desorption, and oxidation treatment.

The device is designed to be installed outdoors, for example, be disposed on the roof of a house, facing sunlight, preferably at right angles. Particulate oil mist in the exhaust gas produced at the kitchen of the house is collected and removed with an electrostatic fumes collector. After the removal of the particulate oil mist, the effluent exhaust gas of the electrostatic fumes collector is gaseous and is composed of air, combusted gas, and VOC gas produced as a result of cooking that has taken place at kitchen. At this point in time, the exhaust gas can be introduced, through an exhaust pipe, into the device. Eventually, the treatment of the VOC gas takes place in the photocatalyst-based exhaust gas treatment UV chamber.

As soon as a cooking session begins at kitchen, the user starts an exhaust hood and an electrostatic fumes collector for collecting and removing the fumes produced as a result of cooking. Then, the VOC gas-containing exhaust gas is conveyed to the device in which the VOC gas is adsorbed to an activated carbon honeycomb plate disposed at the front portion of the exhaust gas treatment chamber of the device to control the adsorption and the desorption of the exhaust-gas-borne VOC gas. Still, a small amount of the VOC gas enters the photocatalyst-based exhaust gas treatment UV chamber to undergo photocatalyst-based exhaust-gas-borne VOC treatment.

With an exhaust hood and an electrostatic fumes collector, particulate oil mist is removed from the exhaust gas produced as a result of cooking taking place at kitchen. Nonetheless, any residual particulate oil mist in the exhaust gas can be adsorbed to the activated carbon honeycomb plate. Since the activated carbon honeycomb plate contains a thermo-catalyst for performing oxidative decomposition of the adsorbed particulate oil mist. In the daytime, sunlight heats up the activated carbon honeycomb plate and activates the catalyst oxidative decomposition of the adsorbed particulate oil mist, thereby efficiently removing the particulate oil mist from the exhaust gas discharged from the exhaust hood and the electrostatic fumes collector, and enhancing the durability of the device.

In the situation where no cooking is taking place at kitchen, sunlight falls on the activated carbon honeycomb plate and thus releases the otherwise adsorbed VOC gas. The released VOC gas enters the photocatalyst-based exhaust gas treatment UV chamber by thermal nature convection to undergo photocatalyst-based exhaust-gas-borne VOC treatment. In the absence of sunlight, it is practicable to turn on the UV lamps in the photocatalyst-based exhaust gas treatment UV chamber, or the blower of the exhaust hood to suct the air from house and flow into the activated carbon honeycomb plate to release a small amount of VOC gas. The released VOC gas enters the photocatalyst-based exhaust gas treatment UV chamber to undergo photocatalyst-based exhaust-gas-borne VOC treatment.

With an exhaust hood and an electrostatic fumes collector, the exhaust gas have 10˜100 part per million (ppm) of VOC in air from cooking place. The device reduces the concentration of the VOC gas in the exhaust gas to less than 1.0 ppm, that is, less than 1.0 ppm, such that it is odorless to human beings. Alternatively, the allowable VOC concentration is deemed the standard concentration in designing the photocatalyst-based exhaust gas treatment chamber. If it is required that concentration of VOC gas in the exhaust gas must be less than 1 part per billion (ppb), it is practicable to use an ozone generator whereby ozone (O₃) is generated and introduced into the device to effectuate oxidative decomposition and deodorization of the VOC gas adsorbed on the activated carbon honeycomb plate. Then, the ozone is introduced into the photocatalyst-based exhaust gas treatment UV chamber which, coupled with photocatalysis, enhances the removal of VOC gas from the exhaust gas so as to enhance the efficiency of the device and further reduce the concentration of VOC gas in the exhaust gas to less than 1.0 ppb.

When irradiated with UV, the photocatalyst coating on the fiberglass sleeve which encloses the exhaust gas treatment UV chamber brings about photocatalysis and thus produces hydroxyl free radical .OH to effectuate exhaust gas VOC oxidation, deodorize the exhaust-gas-borne VOC, and prevent related danger. The photocatalyst in use is provided mainly in the form of nano-TiO₂ Anatase which is superficially impregnated with the precious metal. To enhance photocatalyst-based exhaust-gas-borne VOC treatment, it is practicable that the precious metal is Pt, Pd or Rh of a dosage of 0.1˜1.0 wt % on TiO₂ Anatase, to produce visible light-enabled photocatalysis and low-temperature thermal catalysis. The nano-TiO₂ Anatase is superficially doped with a nano-crystalline transition metal oxide, such as Fe₂O₃, WO₃, or CeO₂, such that the VOC gas can be efficiently removed from the exhaust gas in the photocatalyst-based exhaust gas treatment chamber.

The particulate oil mist in the exhaust gas produced as a result of cooking at kitchen is collected and removed with an exhaust hood and/or an electrostatic fumes collector. Still, a large amount of VOC gas carries VOC-related odor. In view of this, the present invention entails using an catalyst activated carbon honeycomb plate which adsorbs a large amount of VOC gas and a trace of fumes. The adsorbed VOC gas diffuses and then releases into the device again to therefore undergo oxidative decomposition in the photocatalyst-based exhaust gas treatment UV chamber, wherein, in the presence of ozone, the VOC gas is oxidized to produce CO₂ and H₂O before being discharged, thereby effectively removing VOC gas from the exhaust gas, ultimately reducing the concentration of the VOC gas in the exhaust gas to less than 1 ppm, and enhancing the durability of the device.

### BRIEF DESCRIPTION OF THE DRAWINGS

Objectives, features, and advantages of the present invention are hereunder illustrated with specific embodiments in conjunction with the accompanying drawings, in which:

FIG. 1 is a schematic view of a device of deodorizing and minimizing VOC in exhaust gas with photocatalyst according to the present invention;

FIG. 2 is a cross-sectional view of the device according to the present invention;

FIG. 3 is a front view of the device according to the present invention;

FIG. 4 is a structural view of the device according to the present invention;

FIG. 5 is a structural lateral view of the device according to the present invention;

FIG. 6 is a structural schematic view of the photocatalyst-based exhaust gas treatment by the UV lamps according to the present invention;

FIG. 7 is a structural schematic view of a photocatalyst-based exhaust gas treatment with the activated carbon exhaust gas one layer adsorbing box according to the present invention;

FIG. 8 is a structural schematic view of a photocatalyst-based exhaust gas treatment activated carbon twofold exhaust gas two layers adsorbing box according to the present invention; and

FIG. 9 is a structural schematic view of a photocatalyst-based exhaust gas treatment activated carbon fourfold exhaust gas two layers adsorbing box according to the present invention.

### DETAILED DESCRIPTION OF THE PREFERRED EMBODIMENTS

To render the features and advantages of the present invention more obvious and comprehensible, the present invention is hereunder illustrated with specific embodiments.

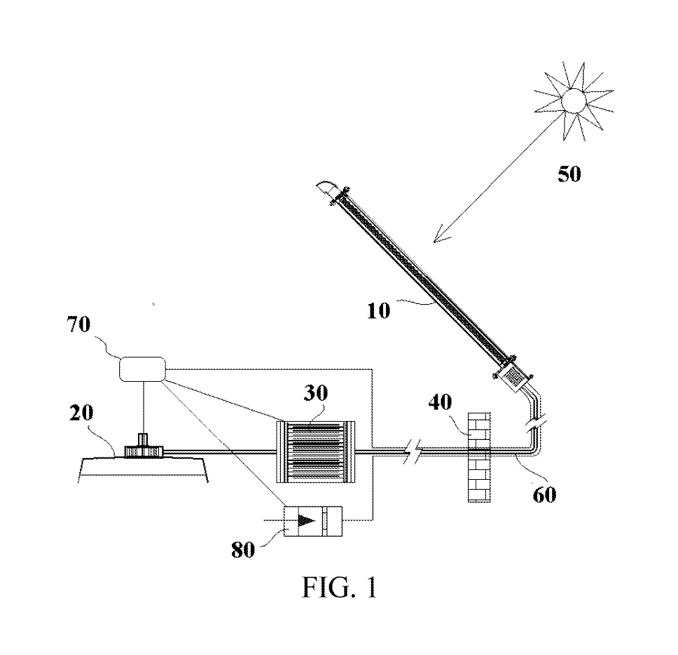

Referring to FIG. 1, a device 10 of deodorizing and minimizing VOC in exhaust gas with photocatalyst is designed to be installed outdoors, for example, be disposed on the roof of a house, facing sunlight, preferably at right angles. Then, the exhaust gas produced at the kitchen of the house is collected with an exhaust hood 20. For particulate oil mist in the exhaust gas is collected and removed with an electrostatic fumes collector 30. At this point in time, the exhaust gas consists of air and the combusted exhaust gas. The combusted exhaust gas essentially comprises volatile organic compound (VOC) gas produced at the kitchen during cooking. Then, the exhaust gas is conveyed with an exhaust pipe 60 to pass through a building's wall 40 into the device 10 for removing the VOC gas from the exhaust gas.

Referring to FIG. 1, the device 10 of the present invention is suitable for use at the kitchens of households as well as the kitchens of small and medium-sized restaurants. To begin a cooking session, a user starts the exhaust hood 20, by a photocatalyst-based exhaust gas treatment control box 70, turn on the photocatalyst-based exhaust gas treatment ultraviolet (UV) lamp 101, and/or the electrostatic fumes collector 30. First, particulate oil mist is removed from the exhaust gas. Then, the exhaust gas is conveyed to the device 10 to remove VOC gas from the exhaust gas. To ensure that the concentration of the residual VOC gas in the exhaust gas is less than 1 part per billion (ppb), the user starts an ozone generator 80 for introducing ozone (O₃) into the device 10. The ozone enters an activated carbon honeycomb plate to undergo oxidative decomposition reaction and deodorization reaction with the adsorbed VOC. Afterward, the ozone is introduced into a photocatalyst-based exhaust gas treatment UV chamber so as to enhance the oxidative decomposition reaction and deodorization reaction taking place on the photocatalyst with the VOC in the exhaust gas. Hence, the efficiency of the device 10 is enhanced, such that the concentration of the residual VOC in the discharged exhaust gas is less than 1 part per billion (ppb).

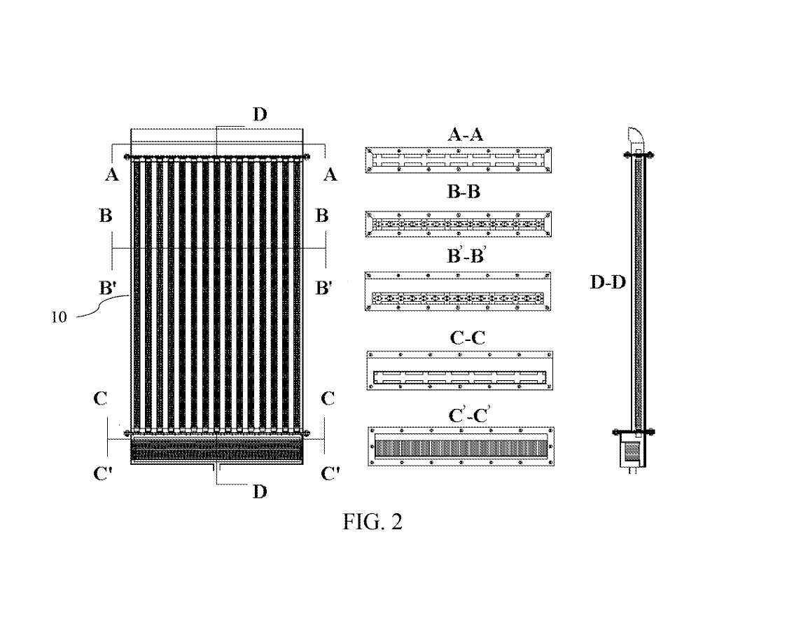

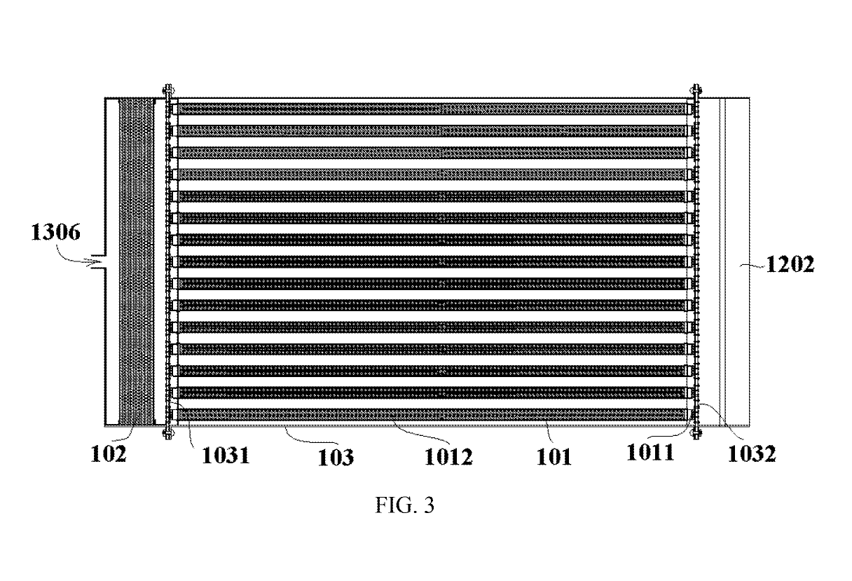

Referring to FIG. 1 through FIG. 5, the photocatalyst-based exhaust gas treatment chamber 10 is installed in a manner to face the sun, adopting a photocatalyst-based exhaust gas treatment UV lamp 101 as the major component, and being disposed in a long flat photocatalyst-based exhaust gas treatment UV chamber 103 and positioned parallel thereto. The photocatalyst-based exhaust gas treatment chamber further comprises a photocatalyst-based exhaust gas treatment UV chamber box 1035 and a glass cover 1033 disposed thereon. The glass cover 1033 is made from transparent colorless borosilicate glass. Borosilicate glass can be penetrated by UVA, whereas quartz glass can be penetrated by UVA, UVB, and UVC. Sunlight is transmitted into the photocatalyst-based exhaust gas treatment UV chamber to fall on the photocatalyst and thereby bring about photocatalysis for treating the hazardous ingredients of the exhaust gas. The glass cover 1033 is sandwiched between flange support 1036 of window glass and a flange 1037 for the glass holder, such that the exhaust gas in the photocatalyst-based exhaust gas treatment UV chamber always undergoes photocatalysis in the day with sunlight, thereby meeting discharge standards. A reflecting mirror 1034 is mounted on the bottom of the photocatalyst-based exhaust gas treatment UV chamber and adapted to increase the amount of sunlight which irradiates the photocatalyst-based UV chamber from back side and thus enhance the efficiency of the photocatalyst-based exhaust gas treatment UV lamp 101 in treating the exhaust gas. In the daytime, sunlight 50 falls on the glass cover 1033 and penetrates the glass cover 1033 to reach the photocatalyst in the photocatalyst-based exhaust gas treatment UV lamp 101, and sunlight 50 reflects off the reflecting mirror 1034 mounted on the bottom of the photocatalyst-based exhaust gas treatment UV chamber, so as to undergo photocatalyst-based exhaust gas treatment.

Referring to FIG. 1 through FIG. 5, the device 10 of the present invention is for use at the kitchens of households and small and medium-sized restaurants. Considering the many types of exhaust gases produced during cooking and the short period of time spent on cooking, the device 10 of the present invention further comprises an activated carbon honeycomb plate 102 for adsorbing the exhaust gases, at least an activated carbon honeycomb plate 102 disposed at an inlet end 130 of the photocatalyst-based exhaust gas treatment chamber 10, and an activated carbon exhaust gas inlet VOC adsorbing box 1302. A glass cover board 1303 is disposed above the activated carbon honeycomb plate 102. The pores of the activated carbon honeycomb plate 102 faces the glass cover board 1303. The glass cover board 1303 is made from transparent colorless Borosilicate glass. Borosilicate glass can be penetrated by UVA, whereas quartz glass can be penetrated by UVA, UVB, and UVC. The purpose of the activated carbon honeycomb plate is to adsorb VOC gas. As the sunlight is shine on the activated carbon honeycomb plate. When irradiated with sunlight and subjected to thermal excitation, the adsorbed VOC gas undergoes desorption and thus is released and diffused to the box, then being conveyed to the photocatalyst-based exhaust gas treatment UV chamber 103 to undergo exhaust gas treatment. Since the glass cover board 1303 is disposed above the activated carbon honeycomb plate 102, it is sandwiched between a window flange support formed by extending an activated carbon honeycomb plate fixing board 1301 and a window flange formed by extending of the exhaust gas inlet VOC adsorbing box 1302.

Referring to FIG. 1 through FIG. 5, to begin a cooking session, the user starts the exhaust hood 20 to remove particulate oil mist from the exhaust gas by centrifugal filtration. Afterward, residual particulate oil mist is collected and removed with the electrostatic fumes collector 30. At this point in time, the exhaust gas contains a large amount of VOC gas produced as a result of the cooking, and the exhaust gas is sent to the device 10 through the exhaust pipe 60. Upon its entry into the photocatalyst-based exhaust gas treatment chamber 10, the exhaust gas is mostly adsorbed to the activated carbon honeycomb plate 102 in the VOC adsorbing box 1302, and then the remaining free portion of the exhaust gas enters the photocatalyst-based exhaust gas treatment UV chamber 103 to undergo photocatalyst-based exhaust gas treatment.

Referring to FIG. 1 through FIG. 5, as mentioned before, a large amount of VOC gas produced as a result of cooking is adsorbed to the activated carbon honeycomb plate 102, and then sunlight 50 falls on the activated carbon honeycomb plate 102, thereby allowing VOC gas of a low concentration to be released from the activated carbon honeycomb plate 102 into the air. The VOC gas thus released undergoes thermal convection to enter the photocatalyst-based exhaust gas treatment UV chamber 103. Afterward, the VOC gas in the photocatalyst-based exhaust gas treatment UV chamber 103 undergoes photocatalyst-based exhaust-gas-borne VOC treatment by photocatalysis which is triggered as soon as sunlight 50 falls on a photocatalyst coating fiberglass sleeve 1012 at the photocatalyst-based exhaust gas treatment UV chamber 1011. Performing photocatalyst-based exhaust-gas-borne VOC treatment by photocatalysis in the aforesaid manner has the following advantages: energy saving, reduction in the required volume of the device 10, and cost reduction. Upon completion of the photocatalyst-based exhaust-gas-borne VOC treatment, the exhaust gas is discharged through an outlet end 120, a bellows 1201, and an outgoing pipe 1203.

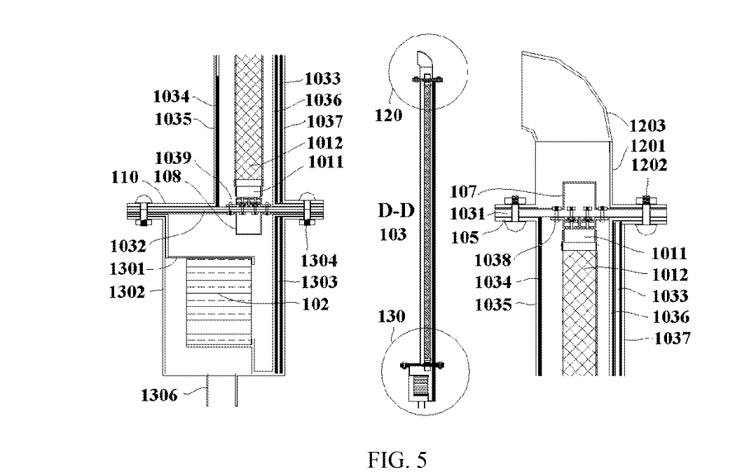

Referring to FIG. 5, at the exhaust gas inlet end 130, it is practicable that the flange of the slender VOC adsorbing box 1302, the flange of the activated carbon honeycomb plate fixing stand 1301, the flange of an inlet end lamp holder covering plate 108, an inlet end lamp holder plate 1032, the flange of a photocatalyst-based exhaust gas treatment UV chamber inlet 110, and the flange 1037 of the glass holder are coupled together and fixed in place, using a bolt nut 1304, for example.

Referring to FIG. 5, at an exhaust gas outlet end 120, it is practicable that the flange of a rectangular exhaust gas outlet windpipe 1201, the flange of an outlet end lamp holder covering plate 107, an outlet end lamp holder plate 1031, the flange of a photocatalyst-based exhaust gas treatment UV chamber 105, and the flange 1037 of the glass holder are coupled together and fixed in place, using a bolt nut 1202, for example.

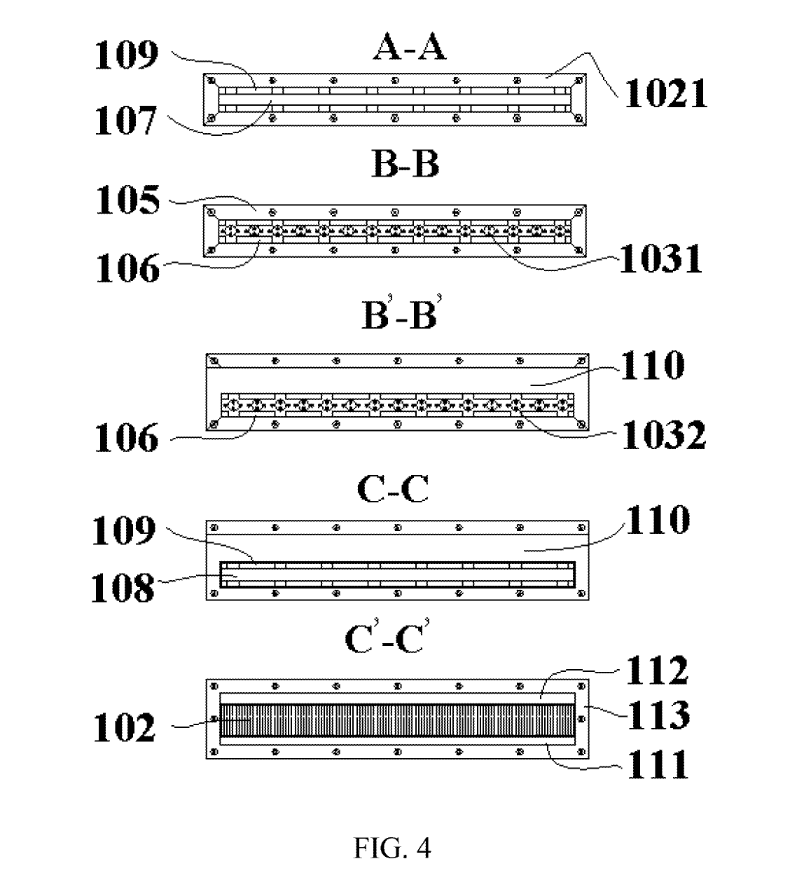

Referring to FIG. 4 (C′-C′), regarding the structure of the device 10, in the VOC adsorbing box 1302 at the inlet end 130, a rectangular activated carbon honeycomb plate fixing stand 1301 partitions the VOC adsorbing box 1302 into three portions, namely an exhaust gas incoming passage 111, the activated carbon honeycomb plate 102, and an exhaust gas outgoing passage 112, such that the exhaust gas is introduced, through an inlet 1306 and then the exhaust gas incoming passage 111, into the activated carbon honeycomb plate 102. Then, the exhaust gas enters the photocatalyst-based exhaust gas treatment UV chamber 103 through the exhaust gas outgoing passage 112.

Referring to FIG. 4 (C-C), the lamp holder rear plate lid 108 disposed at the inlet of the photocatalyst-based exhaust gas treatment UV chamber 103 covers the lamp holder structure and a lighting wire, wherein the lamp holder rear plate lid has a passage 109. Referring to FIG. 4 (B′-B′), the exhaust gas passes through the passage 109 of the lamp holder rear plate lid 108 of the photocatalyst-based exhaust gas treatment UV chamber, and then passes through a passage 106 of the lamp holder plate 1032. Referring to FIG. 4 (B-B), the exhaust gas in the photocatalyst-based exhaust gas treatment UV chamber undergoes photocatalyst-based exhaust gas treatment so as to eliminate VOC gas. Upon completion of the photocatalyst-based exhaust gas treatment UV chamber treatment, the exhaust gas is delivered to the passage 106 of the outlet end lamp holder plate 1031 of the photocatalyst-based exhaust gas treatment UV chamber. Referring to FIG. 4 (A-A), the exhaust gas passes through the passage 109 of the lamp holder rear plate lid 107 before being discharged.

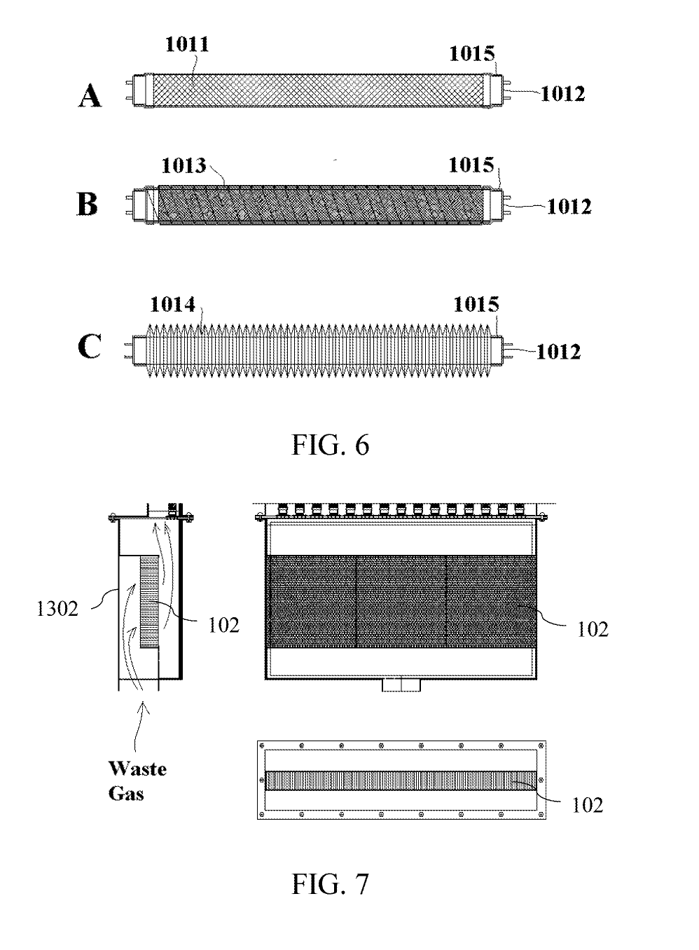

Referring to FIG. 6, regarding the photocatalyst-based exhaust gas treatment UV lamp 101, it is practicable that the photocatalyst coating fiberglass sleeve 1012 is fitted directly to the UV chamber 1011 from outside and fixed in place with a heat-shrinkable rubber sleeve. To increase the amount of the photocatalyst disposed in the photocatalyst-based exhaust gas treatment UV chamber by 3 to 10 times and enhance the efficiency of photocatalyst-based UV chamber exhaust gas treatment carried out with the photocatalyst-based exhaust gas treatment UV lamp 101 by 1 to 3 times, it is practicable that the photocatalyst coating fiberglass sleeve 1012 encloses the UV lamps by superimposed overlapping 1013 or a shrinkable folding sleeve 1014.

The photocatalyst-based exhaust gas treatment chamber is installed in a manner to face the sun, uses the photocatalyst-based exhaust gas treatment UV lamp as an essential component, and is positioned parallel to the long flat photocatalyst-based exhaust gas treatment UV chamber, wherein with VOC adsorbing box has therein an activated carbon honeycomb plate, with a view to treating the exhaust gas emitted from the kitchens of households and small and medium-sized restaurants. During a cooking session, an exhaust hood collects and removes particulate oil mist from the exhaust gas by centrifugal filtration, and any residual particulate oil mist is then collected and removed with an electrostatic fumes collector. At this point in time, the exhaust gas consists mostly of a large amount of VOC gas produced as a result of cooking and can be conveyed through an exhaust pipe to the device 10 and thereby enters the photocatalyst-based exhaust gas treatment chamber. First, a portion of the exhaust gas is adsorbed to the activated carbon honeycomb plate in the VOC adsorbing box, whereas the other portion of the exhaust gas enters the photocatalyst-based exhaust gas treatment UV chamber. The photocatalyst coating fiberglass sleeve is irradiated with UV, and the exhaust gas undergoes photocatalyst-based exhaust gas treatment in the presence of the oxygen and water vapor in the air. For sunlight falls on the photocatalyst disposed in the photocatalyst-based exhaust gas treatment UV chamber to effectuate photocatalyst-based exhaust gas treatment. When sunlight is unavailable, it is practicable to start the photocatalyst-based exhaust gas treatment UV lamp, also bring about photocatalysis whereby hydroxyl free radical .OH is produced, thereby effectuating photocatalyst-based exhaust gas treatment.

### Embodiment 1

Considering the amount of the air current required for household kitchen-oriented exhaust hoods, an exhaust hood with 8.5 CMM=8.5 m³/min is installed at kitchen to convey indoor air to the device 10. In this regard, the photocatalyst-based exhaust gas treatment chamber is of dimensions W90 cm×H20 cm×L200 cm, has an air current speed of 2.0 m/sec, and an incoming/outgoing pipe diameter of 15 cm, wherein the incoming and outgoing pipes are connected to the inlet of the photocatalyst-based exhaust gas VOC deodorization treatment chamber. At the inlet end, the activated carbon honeycomb plate exhaust gas adsorbing box is of dimensions W90 cm×H20 cm×L50 cm, and the activated carbon honeycomb plate is of dimensions W30 cm×L30 cm×H6 cm, wherein three said activated carbon honeycomb plates are inserted into the activated carbon honeycomb plate exhaust gas adsorbing box, as shown in FIG. 7, to adsorb the VOC in the exhaust gas. The photocatalyst-based exhaust gas treatment UV chamber is of dimensions W90 cm×H10 cm×L150 cm, wherein 15 photocatalyst-based exhaust gas treatment UV lamps (40 W), which are arranged parallel to each other and in a monolayer manner as well as spaced apart from each other by a distance of 6 cm, are disposed in the photocatalyst-based exhaust gas treatment UV chamber. Each said photocatalyst-based exhaust gas treatment UV lamp is about dimensions OD3 cm×L120 cm. The photocatalyst-based exhaust gas treatment is carried out mainly in the presence of sunlight. To begin a cook session, the user starts the exhaust hood for collecting and removing particulate oil mist from the exhaust gas by centrifugal filtration. Any residual VOC gas in the exhaust gas is conveyed through an exhaust pipe to the device 10. The residual VOC gas in the exhaust gas is mostly adsorbed to the activated carbon honeycomb plate. Then, the exhaust gas is conveyed to the photocatalyst-based exhaust gas treatment UV chamber in which the residual VOC gas in the exhaust gas undergoes photocatalyst-based oxidation treatment.

In an experiment, the VOC gas is exemplified by butyl acetate, and the butyl acetate is fed to a gas cylinder at a flow rate of 800 sccm under the control of an air mass flow controller. Saturated butyl acetate vapor released from the butyl acetate gas cylinder mixes with the air when drawn into an exhaust hood at a flow rate of 8.5 m³/min, and then the mixture enters the device 10. With a Fourier transform infrared spectroscopy (FTIR), the concentration of butyl acetate in the air along a light path 10 m long in an air chamber is measured to be 2.0 ppm. By contrast, when butyl acetate is adsorbed to the activated carbon honeycomb plate, the concentration of the butyl acetate in the air is measured to be 0.56 ppm. The aforesaid difference in the concentration of the butyl acetate in the air indicates that the concentration of the VOC gas in the exhaust gas will be less than 1.0 ppm, provided that the exhaust hood is operating, so as to draw the exhaust gas into the photocatalyst-based exhaust gas treatment chamber, and then the VOC gas in the exhaust gas is adsorbed to the activated carbon honeycomb plates in the VOC adsorbing box.

In another experiment, the VOC gas is exemplified by butyl acetate, and the butyl acetate is fed to a gas cylinder at a flow rate of 60 sccm under the control of an air mass flow controller. Saturated butyl acetate vapor released from the butyl acetate gas cylinder mixes with the air when drawn into an exhaust hood at a flow rate of 300 L/min, and then the mixture enters the device 10. With a Fourier transform infrared spectroscopy (FTIR), the concentration of butyl acetate in the air is measured to be 1.8 ppm. By contrast, if the exhaust-gas-borne VOC is conveyed to the photocatalyst-based exhaust gas treatment UV chamber to undergo exhaust-gas-borne VOC photocatalytic oxidation treatment, the concentration of butyl acetate in the air is measured to be 0.90 ppm. The aforesaid difference in the concentration of the VOC gas in the exhaust gas shows that the concentration of the VOC gas in the exhaust gas will be less than 1.0 ppm, provided that the VOC gas is removed from the exhaust gas with the photocatalyst-based exhaust gas treatment UV chamber and by UV irradiation and sunlight irradiation.

### Embodiment 2

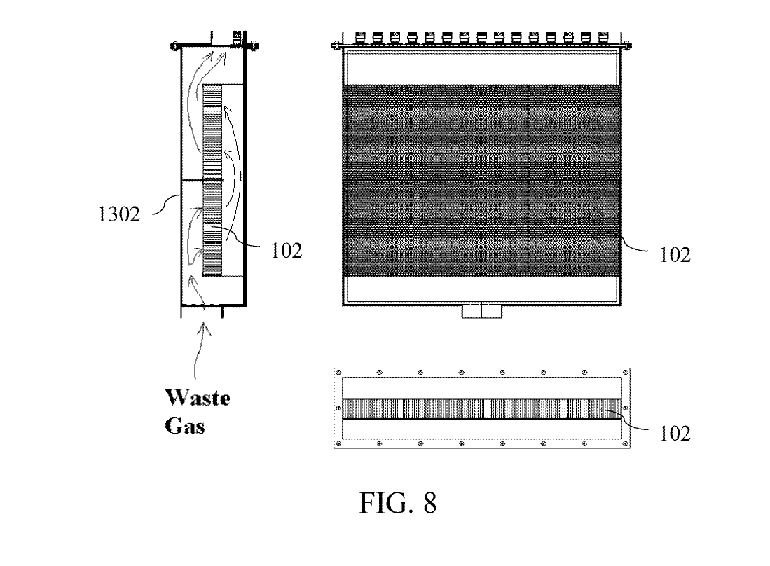

Considering the amount of the air current required for treatment kitchen-oriented exhaust hoods, an exhaust hood 17 CMM=17 m³/min is installed at kitchen to convey indoor air to the device 10 at a flow rate of 4.0 m/sec. At the inlet end, the activated carbon honeycomb plate exhaust gas VOC adsorbing box is of dimensions W90 cm×H20 cm×L80 cm, and the activated carbon honeycomb plates is of dimensions W30 cm×L30 cm×H6 cm, wherein six said activated carbon honeycomb plates are inserted into the activated carbon honeycomb plate exhaust gas VOC adsorbing box and arranged in a bilayer manner, that is, in a front row and in a rear row. The exhaust gas enters the activated carbon honeycomb plates in the front row from behind and leaves the activated carbon honeycomb plates in the front row. Then, the exhaust gas enters the activated carbon honeycomb plates in the rear row from the front. Afterward, the exhaust gas leaves the activated carbon honeycomb plates in the rear row from behind to therefore enter the inlet end of the photocatalyst-based exhaust gas treatment UV chamber, as shown in FIG. 8, thereby intensifying the adsorption of the exhaust-gas-borne VOC gas. The photocatalyst-based exhaust gas treatment UV chamber takes a twofold increase in height to acquire the dimension of W90 cm×H20 cm×L150 cm with a view to reducing the resistance to a exhaust gas flow rate of 17 m3/min in the photocatalyst-based exhaust gas treatment UV chamber.

In general, at a kitchen of a restaurant, the user starts an exhaust hood in order to remove particulate oil mist from the exhaust gas by centrifugal filtration. Any residual particulate oil mist is collected and removed with an electrostatic fumes collector. At this point in time, the exhaust gas essentially consists of a large amount of VOC gas produced as a result of cooking, and the exhaust gas is sent to the device 10 through the exhaust pipe. Upon its entry into the photocatalyst-based exhaust gas treatment chamber, the exhaust gas is mostly adsorbed to the activated carbon honeycomb plate. In the daytime, sunlight shines on the activated carbon honeycomb plates to therefore release the otherwise adsorbed VOC gas, and then the released VOC gas enters the photocatalyst-based exhaust gas treatment UV chamber. Since sunlight irradiates the photocatalyst-based exhaust gas treatment chamber, the VOC gas is oxidized and deodorized with thermal nature convection at a flow rate about 300 L/min. In the daytime and sunlight shines, it does not affect the photocatalyst-based exhaust gas treatment UV chamber in effectuating exhaust-gas-borne VOC treatment, such that the concentration of the exhaust-gas-borne VOC discharged from the kitchen of the restaurant is eventually less than 1.0 ppm, regardless of whether cooking is taking place at the restaurant kitchen.

### Embodiment 3

Considering the amount of the air current required for medium-sized restaurant kitchen-oriented exhaust hoods, an exhaust hood 34 CMM=34 m³/min is installed at kitchen to remove particulate oil mist from the exhaust gas by centrifugal filtration. Any residual particulate oil mist is collected and removed with an electrostatic fumes collector. At this point in time, the exhaust gas essentially consists of a large amount of VOC gas produced as a result of cooking The VOC gas-containing exhaust gas is introduced into the device 10 through the exhaust pipe. This embodiment adopts the device 10 with an air flow rate of 4.0 m/sec. Like embodiment 2, embodiment 3 involves installing two said devices 10, wherein the exhaust gas with an air flow rate of 34 m³/min is divided into two halves each with an air flow rate of 17 m³/min to thereby effectuate exhaust-gas-borne VOC treatment, such that the concentration of the VOC gas in the exhaust gas is eventually less than 1.0 ppm, regardless of whether cooking is taking place at the restaurant kitchen.

### Embodiment 4

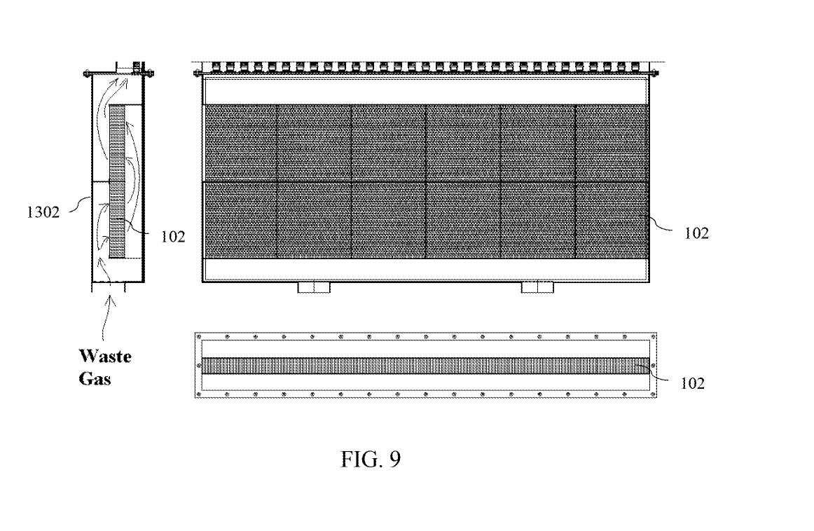

Considering the amount of the air current required for medium-sized restaurant kitchen-oriented exhaust hoods, an exhaust hood 34 CMM=34 m³/min is installed at kitchen to remove particulate oil mist from the exhaust gas by centrifugal filtration. Any residual particulate oil mist is collected and removed with an electrostatic fumes collector. At this point in time, the exhaust gas essentially consists of a large amount of VOC gas produced as a result of cooking. The VOC gas-containing exhaust gas is introduced into the device 10 through the exhaust pipe. This embodiment adopts the device 10 with an air flow rate of 4.0 m/sec. The photocatalyst-based exhaust gas treatment chamber is of dimensions W180 cm×H20 cm×L240 cm. At the inlet end, the activated carbon honeycomb plate exhaust gas adsorbing box is of dimensions W180 cm×H20 cm×L80 cm. The activated carbon honeycomb plates is of dimensions W30 cm×L30 cm×H6 cm, wherein 12 said activated carbon honeycomb plates are inserted into the activated carbon honeycomb plate exhaust gas adsorbing box and arranged in a bilayer manner, that is, in a front row and in a rear row. The exhaust gas enters the six activated carbon honeycomb plates in the front row from behind and leaves the six activated carbon honeycomb plates in the front row. Then, the exhaust gas enters the six activated carbon honeycomb plates in the rear row from the front and leaves the six activated carbon honeycomb plates in the rear row from behind, so as for the exhaust gas to be conveyed to the photocatalyst-based exhaust gas treatment UV chamber at the inlet end, as shown in FIG. 9, thereby enhancing the adsorption of the exhaust-gas-borne VOC gas. The photocatalyst-based exhaust gas treatment UV chamber is of dimensions W180 cm×H20 cm×L130 cm, wherein 30 photocatalyst-based exhaust gas treatment UV lamps (40 W), which are arranged parallel to each other and in a monolayer manner as well as spaced apart from each other by a distance of 6 cm, are disposed in the photocatalyst-based exhaust gas treatment UV chamber. Each said photocatalyst-based exhaust gas treatment UV lamp is of dimensions OD3 cm×L120 cm. The photocatalyst-based exhaust gas treatment is carried out mainly in the presence of sunlight.

### Embodiment 5

To begin a cooking session at the kitchen of a restaurant, follow the steps below. Start an exhaust hood, such that particulate oil mist is removed from the exhaust gas by centrifugal filtration. Since the exhaust gas contains a large amount of particulate oil mist produced as a result of cooking, it is necessary to install an electrostatic fumes collector for removing the particulate oil mist further. As mentioned above, the removal of the particulate oil mist from the exhaust gas is achieved in two steps, namely starting the exhaust hood to remove the particulate oil mist preliminarily, and then starting the electrostatic fumes collector to remove the particulate oil mist thoroughly. Ultimately, the particulate oil mist-free exhaust gas enters the photocatalyst-based exhaust gas treatment chamber and then ends up in the activated carbon honeycomb plates which adsorbs the exhaust-gas-borne VOC gas to remove odor from it. In the daytime, sunlight falls on the activated carbon honeycomb plates to thereby release the otherwise adsorbed VOC gas. Then, the released VOC gas enters the photocatalyst-based exhaust gas treatment UV chamber to effectuate exhaust-gas-borne VOC treatment, such that the concentration of the VOC gas in the exhaust gas is eventually less than 1.0 ppm regardless of whether cooking is taking place in the restaurant kitchen. To allow the concentration of the VOC gas in the exhaust gas to be less than 1 part per billion (ppb), it is practicable that an ozone generator generates ozone and introduces the ozone into the photocatalyst-based exhaust gas treatment chamber. The ozone was adsorbed by the activated carbon honeycomb plates, then oxidized and decomposed with adsorbed VOC gas in activated carbon honeycomb more efficiently, so as to, the ozone can enhanced the photocatalytic oxidized with VOC gas and eliminated the odorous VOC from the exhaust gas in the photocatalyst-based exhaust gas treatment UV chamber, such this the concentration of the odorous VOC gas in the exhaust gas is less than 1 ppb.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A device of deodorizing and minimizing VOC in exhaust gas with photocatalyst, comprising:
a photocatalyst-based exhaust gas treatment ultraviolet (UV) chamber unit; and
an activated carbon honeycomb plate VOC adsorption unit,
wherein the photocatalyst-based exhaust gas treatment UV chamber unit comprises:
a photocatalyst-based exhaust gas treatment UV lamps having therein a photocatalyst, being disposed in a light box, and being parallel thereto; and
the light box having at least a portion thereof made of a UV-penetrable material so as for sunlight to fall on the photocatalyst in the photocatalyst-based exhaust gas treatment UV chamber, wherein the photocatalyst-based exhaust gas treatment UV lampa produce UV for irradiating the photocatalyst in the photocatalyst-based exhaust gas treatment UV chamber, wherein sunlight irradiates the photocatalyst in the photocatalyst-based exhaust gas treatment UV chamber, thereby effectuating exhaust-gas-borne VOC treatment,
wherein the activated carbon honeycomb plate absorption unit comprises an activated carbon honeycomb plate disposed in front of the photocatalyst-based exhaust gas treatment UV chamber unit to adsorb VOC gas in the exhaust gas, wherein the activated carbon honeycomb plate adsorption unit has at least a portion thereof made of a UV-penetrable material whereby sunlight falls on the activated carbon honeycomb plate to trigger release of the VOC gas, allowing the VOC gas to enter the photocatalyst-based exhaust gas treatment UV chamber unit.

2. The device of claim 1, wherein the photocatalyst-based exhaust gas treatment UV chamber emits ultraviolet of 254˜385 nm which falls on the photocatalyst coated fiberglass sleeve to bring about photocatalysis in the presence of oxygen and water vapor in air and thus produce hydroxyl free radical .OH for use in VOC oxidative decomposition and deodorization treatment, wherein the ultraviolet is of an irradiation strength higher than 1.0 mW/cm².

3. The device of claim 1, wherein the photocatalyst comprises nano-TiO₂ Anatase sol and/or superficially doped with 0.1 wt %˜1.0 wt % precious metal selected from Pt, Pd, and Au to effectuate visible light photocatalyst-based VOC removal.

4. The device of claim 1, wherein the photocatalyst-based exhaust gas treatment UV lamps are enclosed with one of a fiber fabric and a fiber sleeve, wherein the fiber fabric and the pipe casing are UV-penetrable and thus neither absorb UV nor are damaged by UV, wherein the fiber fabric and the pipe casing have undergone nano-photocatalyst coating treatment, wherein one of the fiber fabric and the fiber sleeve is disposed on a surface of each said photocatalyst-based exhaust gas treatment UV lamp by one of superimposed overlapping, shrinkable folding, and wrapping, so as to effectuate VOC oxidative decomposition and deodorization treatment.

5. The device of claim 4, wherein the photocatalyst-based exhaust gas treatment by UV lamp can emits ultraviolet for irradiating the photocatalyst to bring about photocatalysis, thereby effectuating VOC oxidative decomposition and deodorization treatment.

6. The device of claim 4, wherein sunlight with UV shine on the photocatalyst to bring about photocatalysis, thereby effectuating VOC oxidative decomposition and deodorization treatment.

7. The device of claim 1, wherein the VOC gas in the exhaust gas is adsorbed to the activated carbon honeycomb plate and then sunlight trigger released and introduced into the photocatalyst-based exhaust gas treatment UV chamber unit to undergo VOC oxidative decomposition and deodorization treatment.

8. The device of claim 1, wherein the activated carbon honeycomb plate, which is wooden paper made in the shape of one of a triangle, a square, or a hexagon, is manufactured by being impregnated with activated carbon powder slurry, baked at 150 C.°, impregnated with a solution of a salt of a transition metal being one of Cu, Ag, and Mn, and subjected to carbonization, metal reduction, and baking in the absence of oxygen, and adapted to effectuate exhaust gas VOC adsorption, desorption, and oxidation treatment.

9. The device of claim 8, wherein the activated carbon honeycomb plate absorbing unit faces sunlight and is adapted to release the VOC gas when irradiated by sunlight and control adsorption and desorption of the VOC gas before the VOC gas enters the photocatalyst-based exhaust gas treatment UV chamber unit, thereby enhance the photocatalyst-based exhaust gas VOC removal and treatment efficiency.

10. A photocatalyst-based VOC deodorization treatment system, comprising an exhaust hood and the device of claim 1 and adapted for use at kitchens of households and restaurants, wherein exhaust gas emitted as a result of cooking is collected by the exhaust hood and then introduced into the device to undergo exhaust-gas-borne VOC treatment.

11. The system of claim 10, further comprising an electrostatic fumes collector whereby fine fumes are removed from the exhaust gas discharged from the exhaust hood, and then the exhaust gas is introduced into the device to undergo exhaust-gas-borne VOC treatment.

12. The system of claim 11, further comprising an ozone generator for generating ozone, wherein the exhaust gas is emitted as a result of cooking and discharged from an exhaust hood, then fumes is removed from the exhaust gas with the electrostatic fumes collector, wherein the fumes-free exhaust gas and the ozone are introduced into an activated carbon honeycomb plate adsorbing unit to undergo adsorbed VOC oxidation treatment and then introduced into the photocatalyst-based exhaust gas treatment UV chamber unit to increase VOC content of the photocatalytically oxidized exhaust gas and enhance efficiency of the device, such that a concentration of VOC in the exhaust gas finally discharged is less than 1 part per billion (ppb).
